(19) United States
(12) Patent Application Publication
(10) Pub. No.: US 2025/0260623 A1
(43) Pub. Date: Aug. 14, 2025

(54) METHOD OF PROVIDING ANALYTICS INFORMATION FOR QOS AND POLICY ASSISTANCE AND DEVICES FOR PERFORMING THE SAME

(71) Applicant: ELECTRONICS AND TELECOMMUNICATIONS RESEARCH INSTITUTE, Daejeon (KR)

(72) Inventors: Myung Ki SHIN, Seoul (KR); Jihoon SUNG, Daejeon (KR)

(73) Assignee: ELECTRONICS AND TELECOMMUNICATIONS RESEARCH INSTITUTE, Daejeon (KR)

(21) Appl. No.: 18/967,062

(22) Filed: Dec. 3, 2024

(30) Foreign Application Priority Data
Feb. 14, 2024 (KR) 10-2024-0021133
Feb. 15, 2024 (KR) 10-2024-0021886
Jun. 5, 2024 (KR) 10-2024-0073504
Aug. 5, 2024 (KR) 10-2024-0103858
Aug. 27, 2024 (KR) 10-2024-0115109
Oct. 4, 2024 (KR) 10-2024-0134688
Nov. 25, 2024 (KR) 10-2024-0169929

(51) Int. Cl. H04L 41/14; H04L 41/5019

(52) U.S. Cl. CPC H04L 41/14; H04L 41/5019

(57) ABSTRACT

A method of providing analytics information for quality of service (QOS) and policy assistance and devices for performing the same are disclosed. The method of providing analytics information includes receiving a request for analytics of QoS and policy assistance from a consumer network function (NF), collecting data for the analytics of the QoS and policy assistance from a 5G core (5GC) NF, generating the analytics information on the QoS and policy assistance based on the collected data, and transmitting the analytics information to the consumer NF.

### CROSS-REFERENCE TO RELATED APPLICATION

This application claims the benefit of Korean Patent Application No. 10-2024-0021133 filed on Feb. 14, 2024, Korean Patent Application No. 10-2024-0021886 filed on Feb. 15, 2024, Korean Patent Application No. 10-2024-0073504 filed on Jun. 5, 2024, Korean Patent Application No. 10-2024-0103858 filed on Aug. 5, 2024, Korean Patent Application No. 10-2024-0115109 filed on Aug. 27, 2024, Korean Patent Application No. 10-2024-0134688 filed on Oct. 4, 2024, and Korean Patent Application No. 10-2024-0169929 filed on Nov. 25, 2024, in the Korean Intellectual Property Office, the entire disclosure of which is incorporated herein by reference for all purposes.

### BACKGROUND

### 1. Field of the Invention

The following disclosure relates to a method of providing analytics information for quality of service (QOS) and policy assistance and devices for performing the same.

### 2. Description of the Related Art

To support network automation, a fifth generation (5G) telecommunication system defines a network data analytics function (NWDAF) that is a network function for providing a function to analyze data collected by the 5G network.

For automation and optimization of the 5G telecommunication system, the NWDAF may collect raw data of each network function and application function, may convert the raw data into big data, and may provide network analytics information by processing the big data. For example, the NWDAF may provide analytics prediction values, such as a service experience, load level information, and network performance, and accuracy information on corresponding analytics to indicate how accurate the prediction values are.

The above description is information the inventor(s) acquired during the course of conceiving the present disclosure, or already possessed at the time, and is not necessarily art publicly known before the present application was filed.

### SUMMARY

To provide policy control and/or quality of service (QOS) satisfaction required by an entity, such as a policy control function (PCF) of a mobile communication system, multi-prediction information, such as a candidate QoS parameter set, a value of each parameter of the candidate QoS parameter set, and predicted quality of experience (QoE), are required. In addition, whether policy control and/or QoS satisfaction derive based on artificial intelligence (AI) are reliable needs to be determined.

An embodiment may provide QoS and policy assistance analytics information for policy control.

An embodiment may provide a method of accuracy monitoring and performance evaluation on QoS and policy assistance analytics information for policy control.

However, the technical aspects are not limited to the aforementioned aspects, and other technical aspects may be present.

According to an embodiment, a method of providing analytics information includes receiving a request for analytics of QoS and policy assistance from a consumer network function (NF), collecting data for the analytics of the QoS and policy assistance from a 5G core (5GC) NF, generating the analytics information on the QoS and policy assistance based on the collected data, and transmitting the analytics information to the consumer NF.

The consumer NF is a policy control function PCF.

The analytics information includes a candidate QoS parameter set, values of individual parameters of the candidate QoS parameter set, and predicted quality of experience (QoE),

The generating includes deriving the analytics information using an observed service experience.

The request includes a request for monitoring analytics accuracy of the analytics of the QoS and policy assistance.

The method further includes receiving analytics feedback information from the consumer NF, wherein the analytics feedback information includes a candidate QoS parameters set indication used for an action. According to an embodiment, a server device for providing analytics information, includes a processor, and a memory electrically connected to the processor and configured to store instructions executable by the processor, wherein, when the instructions are executed by the processor, the instructions cause the server device to perform a plurality of operations, and the plurality of operations includes receiving a request for analytics of QoS and policy assistance from a consumer NF, collecting data for the analytics of the QoS and policy assistance from a 5GC NF, generating the analytics information on the QoS and policy assistance based on the collected data, and transmitting the analytics information to the consumer NF.

The consumer NF is a PCF.

The analytics information includes a candidate QoS parameter set, values of individual parameters of the candidate QoS parameter set, and predicted QoE.

The generating includes deriving the analytics information using an observed service experience.

The request includes a request for monitoring analytics accuracy of the analytics of the QoS and policy assistance.

The plurality of operations further includes receiving analytics feedback information from the consumer NF, and the analytics feedback information includes a candidate QoS parameters set indication used for an action.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a network system according to one embodiment;

FIG. 2 is a diagram illustrating a network data analytics process according to one embodiment;

FIG. 3 is a diagram illustrating an operation of a network data analytics function (NWDAF) according to one embodiment;

FIG. 4 is a diagram illustrating a structure of an NWDAF according to one embodiment;

FIG. 5 is a diagram illustrating quality of service (QOS) and policy assistance analytics processes according to an embodiment;

FIG. 6 is a flowchart illustrating a procedure for deriving and providing QoS and policy assistance analytics according to an embodiment;

FIG. 7 is a diagram illustrating a procedure for subscribing to analytics accuracy information accuracy to an embodiment;

FIG. 8 is a diagram illustrating a procedure for requesting for analytics accuracy information according to an embodiment;

FIG. 9 illustrates an example of a procedure for machine learning (ML) model accuracy monitoring according to one embodiment; and

FIG. 10 is a schematic block diagram of an apparatus for performing an NWDAF according to one embodiment.

### DETAILED DESCRIPTION

The following detailed structural or functional description is provided as an example only and various alterations and modifications may be made to the embodiments. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an example, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like elements and a repeated description related thereto will be omitted.

Terms used herein to identify a connection node, to indicate network entities, to indicate messages, to indicate an interface among network entities, to indicate various pieces of identification information are examples for ease of description. Thus, terms are not limited to terms described later in this disclosure and other terms referring to a subject having the equivalent technical meaning may be used.

Herein, for ease of description, of the currently existing communication standards, terms and names defined by long-term evolution (LTE) and new radio (NR) standards, which are the latest standards defined by the third generation partnership project (3GPP) association, are used. However, embodiments described hereinafter are not limited to the terms and names and a system in compliance with other standards may be applicable in the same manner.

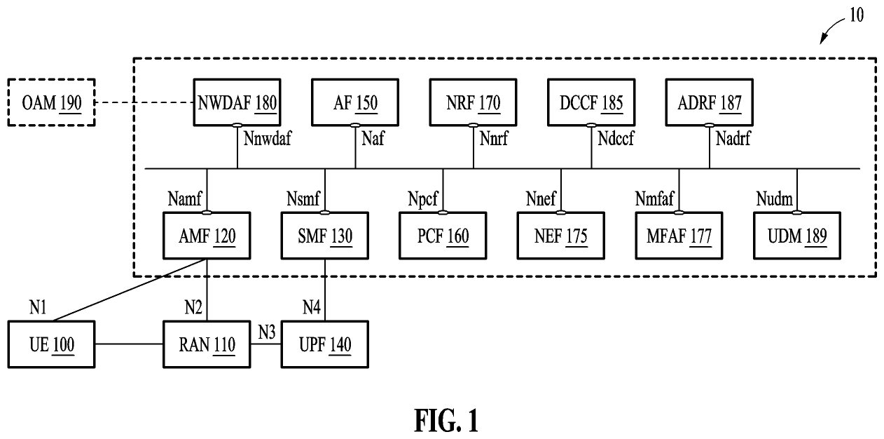

FIG. 1 is a diagram illustrating a network system according to one embodiment.

Referring to FIG. 1, according to an embodiment, a network system 10 (e.g., a 5G network system, a 6G network system, or a 5G/6G network system) may include a plurality of entities 100 to 190. User equipment (UE) (or a user terminal) 100 may be connected to a 5G core network via a radio access network (RAN) 110. The RAN 110 may be a base station providing a wireless communication function to the UE 100. An operation, administration, and maintenance (OAM) 190 may be a system for managing a terminal and a network.

A unit in which each function provided by the network system 10 may be defined as a network function (NF). The NF may include an access and mobility management function (AMF) 120, a session management function (SMF) 130, a user plane function (UPF) 140, an application function (AF) 150, a policy control function (PCF) 160, a network repository function (NRF) 170, a network exposure function (NEF) 175, a messaging framework adapter function (MFAF) 177, a network data analytics function (NWDAF) 180, a data collection coordination function (DCCF) 185, an analytics data repository function (ADRF) 187, and a unified data management (UDM) 189. The AMF 120 may manage network access and mobility of a terminal, the SMF 130 may perform a function associated with a session, the UPF 140 may transmit user data, and the AF 150 may communicate with a 5G core (5GC) to provide an application service. The PCF 160 may manage a policy, and the NRF 170 may store status information of an NF and may process a request to find an NF accessible by other NFs.

The NWDAF 180 may provide an analytics result by analyzing data collected in a network (e.g., a 5G network) to support network automation. The NWDAF 180 may collect, store, and analyze information from the network. The NWDAF 180 may collect information from the OAM 190, an NF (e.g., the AMF 120, the SMF 130, the UPF 140, the PCF 160, the NRF 170, the NEF 175, the MFAF 177, the DCCF 185, the ADRF 187, and/or the UDM 189) constituting a network, the UE 100, or the AF 150. The NWDAF 180 may provide an analytics result to an unspecified NF (e.g., the AMF 120, the SMF 130, the UPF 140, the PCF 160, the NRF 170, the NEF 175, the MFAF 177, the DCCF 185, the ADRF 187, and/or the UDM 189), the OAM 190, the UE 100, or the AF 150. The analytics result may be independently used by each NF (e.g., the AMF 120, the SMF 130, the UPF 140, the PCF 160, the NRF 170, the NEF 175, the MFAF 177, the DCCF 185, the ADRF 187, and/or the UDM 189), the OAM 190, the UE 100, or the AF 150.

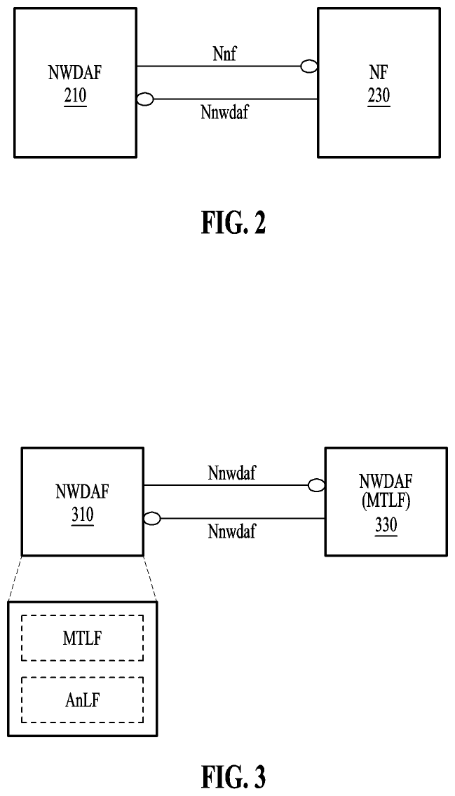

FIG. 2 is a diagram illustrating a network data analytics process according to one embodiment.

An NWDAF 210 may provide an NWDAF service to an NF 230. The NWDAF service may include a service, such as analytics information subscription (Nnwdaf_AnalyticsSubscription), analytics information requesting (Nnwdaf_AnalyticsInfo), data management (Nnwdaf_DataManagement), machine learning (ML) model provisioning (Nnwdaf_MLModelProvision), ML model information requesting (Nnwdaf_MLModelInfo), ML model monitoring (Nnwdaf_MLModelMonitor), ML model training (Nnwdaf_MLModel Training), ML model training information requesting (Nnwdaf_MLModelTrainingInfo), roaming user analytics (Nnwdaf_RoamingAnalytics), and roaming data management (Nnwdaf_RoamingData). The NWDAF service provided by the NWDAF 210 may be shown in Table 1.

TABLE 1

| Service Name | Service Operations | Operation Semantics | Example Consumer(s) |
|---|---|---|---|
| Nnwdaf_AnalyticsSubscription | Subscribe | Subscribe/Notify | PCF, NSSF, AMF, SMF, NEF, AF, |
| | | | OAM, CEF, NWDAF, DCCF, LMF |
| | Unsubscribe | | PCF, NSSF, AMF, SMF, NEF, AF, |
| | | | OAM, CEF, NWDAF, DCCF, LMF |
| | Notify | | PCF, NSSF, AMF, SMF, NEF, AF, |
| | | | OAM, CEF, NWDAF, DCCF, MFAF, |
| | | | LMF |
| | Transfer | Request/Response | NWDAF |
| Nnwdaf_AnalyticsInfo | Request | Request/Response | PCF, NSSF, AMF, SMF, NEF, AF, |
| | | | OAM, CEF, NWDAF, DCCF, LMF |
| | ContextTransfer | Request/Response | NWDAF |
| Nnwdaf_DataManagement | Subscribe | Subscribe/Notify | NWDAF, DCCF |
| | Notify | | NWDAF, DCCF, MFAF, ADRF |
| | Fetch | Request/Response | NWDAF, DCCF, MFAF, ADRF |
| Nnwdaf_MLModelProvision | Subscribe | Subscribe/Notify | NWDAF |
| | Unsubscribe | | NWDAF |
| | Notify | | NWDAF |
| Nnwdaf_MLModelInfo | Request | Request/Response | NWDAF |
| Nnwdaf_MLModelMonitor | Subscribe | Subscribe/Notify | NWDAF |
| | Unsubscribe | | NWDAF |
| | Notify | | NWDAF |
| | Register | Request/Response | NWDAF |
| | Request | | NWDAF |
| Nnwdaf_MLModelTraining | Subscribe | Subscribe/Notify | NWDAF |
| | Unsubscribe | | NWDAF |
| | Notify | | NWDAF |
| Nnwdaf_MLModelTrainingInfo | Request | Request/Response | NWDAF |
| Nnwdaf_RoamingAnalytics | Subscribe | Subscribe/Notify | H-RE-NWDAF, V-RE-NWDAF |
| | Unsubscribe | | H-RE-NWDAF, V-RE-NWDAF |
| | Notify | | H-RE-NWDAF, V-RE-NWDAF |
| | Request | Request/Response | H-RE-NWDAF, V-RE-NWDAF |
| Nnwdaf_RoamingData | Subscribe | Subscribe/Notify | H-RE-NWDAF, V-RE-NWDAF |
| | Unsubscribe | | H-RE-NWDAF, V-RE-NWDAF |
| | Notify | | H-RE-NWDAF, V-RE-NWDAF |

Note 1:
How OAM consumes Nnwdaf services and which Analytics information is relevant is defined in TS 28.550 [7] Annex H and out of the scope of this TS.
Note 2:
How CEF consumes Nnwdaf services and which Analytics information is relevant is defined in TS 28.201 [21] and out of the scope of this TS.
Note 3:
The Nnwdaf_MLModelProvision service and the Nnwdaf_MLModelInfo service are provided by an NWDAF containing MTLF and consumed by an NWDAF containing AnLF.

The NWDAF 210 may perform analytics in response to a request from the NF 230 and may provide the analytics information (e.g., an analytics result) to the NF 230. The NWDAF 210 may provide the analytics information as shown in Table 2 according to the service described in Table 1.

TABLE 2

| Analytics | | |
|---|---|---|
| Information | Request Description | Response Description |
| Slice load level | Analytics ID: load level | A load level may be provided as the |
| information | information | number of UE registrations and the |
| | | number of PDU sessions for a network |
| | | slice and network slice instances as well |
| | | as resource utilization for network slice |
| | | instances. |
| Observed service | Analytics ID: service experience | Observed service experience statistics or |
| experience | | predictions may be provided for a network |
| information | | slice or an application. They may be |
| | | derived from an individual UE, a group of |
| | | UEs or any UE. The slice service |
| | | experience may be derived from an |
| | | application, a set of applications, or all |
| | | applications on the network slice. |
| NF load | Analytics ID: NF load information | Load statistics or predictions information |
| information | | on specific NF(s) |
| Network | Analytics ID: network | Statistics or predictions on the load in an |
| performance | performance | area of interest; in addition, statistics or |
| information | | predictions on the number of UEs that are |
| | | located in that area of interest. |
| UE mobility | Analytics ID: UE mobility | Statistics or predictions on UE mobility. |
| information | | When the visited area of interest (AOI) is |
| | | included in the analytics filter |
| | | information, only statistics on UE |
| | | mobility may be provided. |
| UE | Analytics ID: UE communication | Statistics or predictions on UE |
| communication | | communication. |
| information | | |
| Expected UE | Analytics ID: UE mobility and/or | Analytics on UE mobility and/or UE |
| behavioral | UE communication | communication |
| parameters | | |
| UE abnormal | Analytics ID: abnormal behavior | List of observed or expected exceptions, |
| behavior | | with exception ID, exception level and |
| information | | other information depending on the |
| | | observed or expected exceptions. |
| E2E data volume | Analytics ID: E2E data volume | Analytics on E2E data volume transfer |
| transfer time | transfer time | time. |
| User data | Analytics ID: user data congestion | Statistics or predictions on the user data |
| congestion | | congestion for transfer over the user |
| information | | plane, for transfer over the control plane, |
| | | or for both. |
| QoS | Analytics ID: QoS sustainability | For statistics, the information on the |
| sustainability | | location and the time for the QoS change |
| | | and the threshold(s) that were crossed; or, |
| | | for predictions, the information on the |
| | | location and the time when a potential |
| | | QoS change may occur and what |
| | | threshold(s) may be crossed. |
| Session | Analytics ID: session management | Statistics on session management |
| management | congestion control experience | congestion control experience for a |
| congestion | | specific deep neural network (DNN) |
| control | | and/or single network slice selection |
| experience | | assistance information (S-NSSAI). |
| Redundant | Analytics ID: redundant | Statistics or predictions aimed at |
| transmission | transmission experience | supporting redundant transmission |
| experience | | decisions for URLLC services. |
| WLAN | Analytics ID: WLAN | Statistics or predictions on WLAN |
| performance | performance | performance of UE. |
| Dispersion | Analytics ID: UE dispersion | Statistics or predictions that identify the |
| | | location (i.e. areas of interest) or network |
| | | slice(s) where a UE, or a group of UEs |
| | | disperse their data volume, or disperse |
| | | mobility or session management |
| | | transactions or both. |
| DN(data | Analytics ID: DN performance | Statistics or predictions on user plane |
| network) | | performance for a specific edge |
| performance | | Computing application. |
| PFD | Analytics ID: PFD determination | Statistics on PFD information for a known |
| determination | | application identifier(s). |
| Movement | Analytics ID: movement behavior | Statistics or predictions on movement |
| behavior | | behavior for an applicable area |
| Location | Analytics ID: location accuracy | Predictions on location accuracy. |
| accuracy | | |
| Relative | Analytics ID: relative proximity | Statistics or predictions on relative |
| proximity | | proximity among UEs. |
| PDU session | Analytics ID: PDU session traffic | Statistics on whether traffic of UEs via |
| traffic | | one or multiple PDU sessions is according |
| | | to the information provided by the service |
| | | consumer. |
| QoS and policy | Analytics ID: QoS and policy | Analytics on predicted QoE for QoS |
| assistance | assistance | parameter set(s) |

For example, in response to a request (e.g., Analytics ID=analytics on “QoS and Policy Assistance”) from the NF 230 (e.g., the PCF 160), the NWDAF 210 may analyze “QoS and Policy Assistance” and may provide an analysis on predicted quality of experience (QoE) for a QoS parameter set as the analytics information to the NF 230.

An NWDAF 210 may provide an analytics information subscription service (Nnwdaf_AnalyticsSubscription service) to an NF 230. The NF 230 may be the UE 100, the RAN 110, the AMF 120, the SMF 130, the UPF 140, the AF 150, the PCF 160, the NRF 170, the NEF 175, the MFAF 177, the DCCF 185, the ADRF 187, and/or the OAM 190 of FIG. 1.

The analytics information subscription service may be a service to subscribe to or unsubscribe from a network data analytics result generated by the NWDAF 210. In addition, the analytics information subscription service may be a service to selectively subscribe to or unsubscribe from analytics accuracy information. The analytics information subscription service may be divided into periodically receiving a network analytics result and/or analytics accuracy information according to the needs of a network function of the NF 230 that subscribes to the service and receiving an analytics result and/or the analytics accuracy information when a predetermined condition is satisfied. The analytics information subscription service may be provided through three operations of subscribing, unsubscribing, and notifying.

The subscription operation (Nnwdaf_AnlayticsSubscription_Subscribe operation) may subscribe to NWDAF analytics and/or analytics accuracy information using specific parameters. The subscription operation (Nnwdaf_AnlayticsSubscription_Subscribe operation) may selectively subscribe to the analytics accuracy information. The subscription operation (Nnwdaf_AnlayticsSubscription_Subscribe operation) may include a required input and/or an optional input. The required input may include a single network slice selection assistance information (S-NSSAI), an event identifier (ID) or an analytics ID, a notification target address, and an event reporting information. The optional input may include information additionally required for analytics information processing. For example, the optional input may include information about an event filter or an analytics filter (or an analytics information filter). However, the example is not limited thereto.

An example of one or more parameters included in the Nnwdaf_AnlayticsSubscription_Subscribe service operation may be as follows:
(1) Inputs, Required:
   Analytics ID (or a set of analytics IDs);
   Target of analytics reporting;
   Notification target address (+Notification correlation ID);
   Analytics reporting parameters (e.g., including an analytics target period, etc.).

The target of analytics reporting may be provided for each individual analytics ID.
(2) Inputs, Optional:
   Analytics filter information;
   Time window for collecting historical analytics;
   Subscription correlation ID (e.g., in the case of modification of analytics subscription);
   Preferred level of accuracy of the analytics;
   Preferred level of accuracy per analytics subset;
   Reporting thresholds;
   Maximum number of requested objects (max);
   Preferred order of results, maximum number of requested SUPIs (SUPImax);
   Time when analytics information is needed;
   Analytics metadata request;
   NWDAF identifier (or a set of NWDAF identifiers) used by a consumer NF (e.g., an NWDAF service consumer) when aggregating multiple analytics subscriptions
   Dataset statistical properties;
   Output strategy;
   Data time window;
   Serving area of the consumer NF or NF ID;
   Information on previous analytics subscription (e.g., an NWDAF identifier (e.g., an instance ID or a set ID), an analytics ID (e.g., including an SUPI with respect to UE-related analytics and analytics filter information), and a subscription correlation ID);
   Use case context (e.g., indicates a use case and an environment in which analytics (or analytics information) is used)
   Analytics accuracy request information.
   Analytics feedback information:

The analytics feedback information indicates that an analytics consumer NF has taken an action affected by previously provided analytics (e.g., an analytics result), which may or may not affect ground truth data corresponding to an analytics ID requested at the time when prediction refers to, and may consequently affect ML model accuracy monitoring by subscription using the following parameter(s). The following parameters may include candidate QoS parameter set indications used for an action when the analytics ID is set to “QoS and Policy Assistance”.
QoS parameter set(s), value(s) of individual parameters in QoS parameter set(s), and an input value for QoE

Analytics filter information, reporting thresholds, a maximum number of requested objects (max), a maximum number of requested SUPIs (SUPImax), an analytics metadata request, dataset statistical properties, an output strategy, a data time window, and a required time for analytics information may be provided per individual analytics ID.

The analytics feedback information may be included in a modification request for an existing analytics subscription.

Another input parameter for another analytics ID may be required.
(3) Output, Required:

Subscription correlation ID if the subscription is accepted (required to manage the subscription)

Error response if the subscription is not accepted
(4) Outputs, Optional:

If available and a consumer NF (e.g., an analytics consumer) requests for immediate reporting, a first corresponding analytics report may be included.

When a target of analytics reporting is a SUPI or a GPSI, the subscription may not be accepted (e.g., the user consent may not be granted and an error may be sent to the user). When a target of analytics reporting is an internal group ID, a list of SUPIs or GPSIs, or UE, no error may be sent but when the user consent is not granted, a SUPI or a GPSI may be skipped.

In the case of an unsubscription operation (Nnwdaf_AnlayticsSubscription_Unsubscribe operation), the NF 230 may transmit subscription ID information to the NWDAF 180 and the NWDAF 210 may transmit a message notifying confirmation of unsubscription to the NF 230 requesting unsubscription as an output.

The notification operation (Nnwdaf_AnlayticsSubscription_Notify operation) may be that the NWDAF 210 notifies the NF 230, which successfully subscribes to the analytics information subscription service, of a specified network data analytics result periodically or when a predetermined condition is satisfied, and/or analytics accuracy information. The notification operation may include an event ID or an analytics ID (or analytics information ID) and a notification target address.

The NWDAF 210 may provide an analytics information request service to the NF 230. Unlike the analytics information subscription service, the analytics information request service may be a service in which the NF 230 requests analytics on predetermined information and/or analytics accuracy information and receives a result value as soon as the request is completed. An operation of the analytics information request service may include a request and a response. The NF 230 that requests analytics information and/or analytics accuracy information may transmit an analytics information request message to the NWDAF 180.

An example of one or more parameters included in the Nnwdaf_AnalyticsInfo_Request service operation may be as follows:
(1) Inputs, Required:
   Analytics ID (or a set of analytics IDs);
   Target of analytics reporting;
   Analytics reporting parameters (e.g., including an analytics target period, etc.). The target of analytics reporting may be provided for each individual analytics ID.
(2) Inputs, Optional:
   Analytics filter information;
   Preferred level of accuracy of the analytics;
   Preferred level of accuracy per analytics subset;
   Time when analytics information is needed;
   Maximum number of requested objects (max);
   Preferred order of results, maximum number of requested SUPIs (SUPImax);
   Analytics metadata request;
   Dataset statistical properties;
   Output strategy;
   Data time window;
   Use case context (e.g., indicates a use case and an environment in which analytics (or analytics information) is used)
   Time window for historical analytics;
   Analytics accuracy request information;
   QoS parameter set(s), value(s) of individual parameters in QoS parameter set(s), and an input value for QoE

Analytics filter information, reporting thresholds, a maximum number of requested objects (max), a maximum number of requested SUPIs (SUPImax), an analytics metadata request, dataset statistical properties, an output strategy, a data time window, and a required time for analytics information may be provided per individual analytics ID.
(3) Output, Required:

Tuple (e.g., analytics IDs, analytics specific parameters) if the request is accepted Error response if the subscription is not accepted
(4) Outputs, Optional:

Timestamp of analytics generation (e.g., required when the ADRF is deployed), validity period, confidence, revised waiting time, analytics metadata information, and analytics accuracy information.

The validity period may be provided as a part of specific analytics parameters on some NWDAF output analytics.

When a target of analytics reporting is a SUPI or a GPSI, the subscription may not be accepted (e.g., the user consent may not be granted and an error may be sent to the user). When a target of analytics reporting is an internal group ID, a list of SUPIs or GPSIs, or UE, no error may be sent but when the user consent is not granted, a SUPI or a GPSI may be skipped.

Other input or output parameters may be required for another analytics ID.

The NWDAF 210 may transmit the analytics result and/or the analytics accuracy information to each requesting NF 230. The analytics result and/or the analytics accuracy information may be used to optimize the performance of an operation (or a network function) (e.g., quality of service (QOS) management, traffic control, mobility management, load balancing, and power management of a terminal) performed by the NF 230.

The NF 230 may be a consumer NF (or a demander NF) requesting the NWDAF 210 for the analytics result and/or the analytics accuracy information and may provide feedback on the analytics result (e.g., analytics feedback information) to the NWDAF 210. The NF 230 may be a consumer NF (e.g., a service consumer NF) of the network data analytics service. The NWDAF 210 may function to collect and analyze data from each NF 230 to generate the analytics result and/or the analytics accuracy information requested by the consumer NF and may improve the accuracy of analytics information by collecting the analytics feedback information from the consumer NF to which the NWDAF 210 provided analytics. The NWDAF 210 may transmit the analytics result and/or the analytics accuracy information to the consumer NF transmitting the analytics request (e.g., including analytics and/or analytics accuracy information). Accordingly, the NWDAF 210 may be a provider NF of the analytics result and/or the analytics accuracy information requested by the consumer NF. The NWDAF 210 may be a service provider NF of a service that provides an analytics result requested by a consumer NF.

The NWDAF 210 may include at least one of an analytics logical function (AnLF) and a model training logical function (MTLF). The NWDAF 210 may include the MTLF and AnLF, respectively, or may support both.

The NWDAF (e.g., the NWDAF 210) including the AnLF may perform inference and may derive analytics information and/or analytics accuracy information (e.g., derive statistics and/or prediction and/or analytics accuracy in response to an analytics consumer request or a request by an analytics model provider (an NWDAF including an MTLF). The NWDAF including the AnLF may expose a network data analytics service (e.g., Nnwdaf_AnalyticsSubscription or Nnwdaf_AnalyticsInfo).

An NWDAF (e.g., the NWDAF 210) including the MTLF may train a machine learning (ML) model and may expose a new training service (e.g., provide an initial version that is not trained or a trained model).

When an ML model may be provided and/or trained for an analytics ID, the NWDAF including the MTLF may register (e.g., register to the NRF) an ML model provisioning service, a training service, and a monitoring service (e.g., Nnwdaf_MLModelProvision, Nnwdaf_MLModelInfo, Nnwdaf_MLModelUpdate, Nnwdaf_MLModelTraining, and Nnwdaf_MLModelTrainingInfo).

When the ML model may be used and/or monitored, the NWDAF including the AnLF may register (e.g., register to the NWDAF including the MTLF) an ML model monitoring service (e.g., Nnwdaf_MLModelMonitor). The NWDAF including the MTLF may collect feedback (e.g., analytics feedback information) on an analytics result of using the ML model provided through the ML model monitoring service and/or analytics accuracy information from the NWDAF including the AnLF.

Hereinafter, a method of determining the accuracy of analytics information by an NWDAF is described.

An NWDAF may have a capability of examining the accuracy (accuracy checking capability) of analytics and/or an ML model, and in response to a request, the NWDAF may provide accuracy information to a consumer or may use the accuracy information for an internal process.

Input data may be collected from a data producer NF in response to an inference or prediction request for each analytics ID of the NWDAF for a specific time period in future, and ground truth data may be collected from a data producer NF corresponding to a requested analytics ID when prediction refers to. The ground truth data may be actual measured data observed when prediction refers to.

When an action triggered by an analytics output of a consumer is shown in the analytics feedback information, the ground truth data may be affected.

The analytics or ML model accuracy monitoring may be performed by comparing predictions using a currently trained ML model and corresponding ground truth data e.g., corresponding true observed events). The analytics or ML model accuracy information (e.g., a result of analytics or ML model accuracy monitoring) may indicate respective general performance measurement of the analytics and the ML model and this may be constituted by the number of correct predictions among the total predictions and the number of corresponding samples.

A method of determining accuracy of prediction by an MTLF or AnLF may vary depending on implementation.

The NWDAF (e.g., the NWDAF including the AnLF and/or the MTLF) having the accuracy checking capability may determine to begin analytics accuracy monitoring based on the following.
Request by an analytics accuracy consumer. For example, the analytics accuracy consumer may be an NWDAF including the AnLF and/or an NWDAF including the MTLF and/or the analytics consumer NF.
Analytics feedback information provided by the analytics consumer NF.

The AnLF having an analytics accuracy checking capability may provide or notify an analytics consumer of a corresponding service of accuracy information of an analytics ID, and when the analytics accuracy does not satisfy a requirement of the analytics consumer, the analytics consumer may stop the use of analytics for a predetermined period or may be provided with new analytics. In addition, when updated analytics for the provided analytics ID are able to be generated in a correction time period, the updated analytics may be provided in response to a request of the analytics consumer.

The AnLF having the analytics accuracy checking capability may determine the analytics accuracy information based on as follows:
Comparing prediction generated based on an ML model and corresponding ground truth data
Determining analytics accuracy by comparing analytics accuracy using multiple ML models

The MTLF having an ML model accuracy checking capability may determine ML model performance degradation based on as follows:
Data including input data and/or analytics results and/or ground truth data (e.g., ground truth data collected from various data source NFs, a DCCF, an AnLF, an ADRF, and a UDM, or ground truth data configured by an OAM); or
AnLF providing a notification of the analytics accuracy information; or
AnLF providing analytics feedback information on analytics generated by the ML model

The NWDAF including the MTLF may reselect a new ML model or retrain an existing ML model, and consequently, may notify an ML model consumer of ML model accuracy degradation. In addition, the NWDAF including the MTLF may consider the rating of an unreliable AF when using the unreliable AF as a data source.

FIG. 3 is a diagram illustrating an operation of an NWDAF according to one embodiment.

The NWDAF 310 may include at least one of an AnLF and an MTLF and the NWDAF 330 may include an MTLF.

The NWDAF 310 may use a provisioning service operation (e.g., Nnwdaf_MLModelProvision) and a training service operation (e.g., Nnwdaf_MLModelTraining) for an ML model trained in an NWDAF 330.

The AnLF may perform inference, may derive (e.g., derive statistics and/or prediction in response to an analytics consumer request) analytics information, and may expose an analytics service (e.g., Nnwdaf_AnalyticsSubscription or Nnwdaf_AnalyticsInfo). The MTLF may train an ML model and may expose a new training service (e.g., provide a trained ML model and train an ML model). The AnLF and/or the MTLF may perform ML model analytics accuracy monitoring and may expose analytics accuracy information of the ML model. An operation of ML model analytics accuracy monitoring may include an operation of generating the analytics accuracy information of the ML model.

The AnLF may support a data analytics information request service (e.g., Nnwdaf_AnalyticsInfo) or an analytics subscription service (e.g., Nnwdaf_AnalyticsSubscription). The MTLF may support an ML model provisioning service (e.g., Nnwdaf_MLModelProvision), an ML model information request service (e.g., Nnwdaf_MLModelInfo), an ML model training service (e.g., Nnwdaf_MLModelTraining), and an ML model training information request service (e.g., Nnwdaf_MLModelTrainingInfo).

The NWDAF 310 may subscribe to or unsubscribe from the ML model accuracy (e.g., the analytics accuracy of the ML model) information monitored through an Nnwdaf_MLModelMonitor service. The Nnwdaf_MLModelMonitor service may additionally provide analytics feedback information and/or analytics accuracy information on analytics generated by the NWDAF 310. The NWDAF 310 may register the use and monitoring capabilities of the ML model to the NWDAF 330 that is a model provider. The Nnwdaf_MLModelMonitor service may include an Nnwdaf_MLModelMonitor_Subscribe service operation, an Nnwdaf_MLModelMonitor_Unsubscribe service operation, an Nnwdaf_MLModelMonitor_Notify service operation, an Nnwdaf_MLModelMonitor_Register service operation, and an Nnwdaf_MLModelMonitor_Deregister service operation.
(1) Nnwdaf_MLModelMonitor_Subscribe service operation

The Nnwdaf_MLModelMonitor_Subscribe service operation may subscribe to an NWDAF (e.g., the NWDAF 330), which provides an ML model, for ML model accuracy (e.g., the analytics accuracy of a model) information and analytics feedback information (e.g., analytics feedback information on analytics generated by an NWDAF (e.g., the NWDAF 310) including an AnLF) using a predetermined parameter.
i) Inputs, Required:

Unique ML model identifier (or a set of unique ML model identifiers), notification target address (+notification correlation ID).
ii) Inputs, Optional:

Subscription correlation ID (e.g., in the case of modification of ML model monitoring subscription), accuracy metrics indicating metrics for accuracy information calculation, an ML model accuracy information period indicating a reporting periodicity for reporting information, and an accuracy reporting threshold indicating a reporting condition to report the accuracy information.
iii) Outputs, Required:

When the subscription is accepted: Subscription correlation ID (required to manage the subscription), an expiry time (required if the subscription is allowed to be expired based on a policy of an operator).
iv) Outputs, Optional: None.
(2) Nnwdaf_MLModelMonitor_Unsubscribe service operation

A consumer NF may unsubscribe from an NWDAF for ML model accuracy (e.g., analytics accuracy of an ML model) information and analytics feedback information on analytics generated by the NWDAF.
i) Inputs, Required: Subscription correlation ID.
ii) Outputs, Required: Operation execution result indication.
iii) Outputs, Optional: None.
(3) Nnwdaf_MLModelMonitor_Notify service operation

An NWDAF may notify a consumer instance subscribing to a specific NWDAF service of ML model accuracy (e.g., analytics accuracy of an ML model) information and analytics feedback information on analytics generated by the NWDAF (the same as the NWDAF mentioned above).
i) Inputs, Required: Notification correlation information, at least one of the following:
   Tuple (e.g., a unique ML model identifier, ML model accuracy information): The ML model accuracy information may include a deviation value indicating a deviation of prediction generated by using an ML model from ground truth data, network data shown as an ADRF ID and/or DataSetTag when the deviation occurs (e.g., an NWDAF including an MTLF may be used for available ML model retraining), and an accuracy metric requested by the subscription service operation; and
   Analytics feedback information: indicates that a consumer NF of analytics generated by a provisioned ML model takes an action affected by the analytics and includes the following parameter:
   Analytics ID used to take an action;
   Corresponding ML model identifier used for generating analytics;
   Indication whether an action affects ground truth data (if available);
   Timestamp when the action is performed.
   Use case context (e.g., indicates a use case and an environment in which analytics (or analytics information) is used) (if available).
ii) Inputs, Optional: Validity period.
iii) Outputs, Required: Operation execution result indication.
iv) Outputs, Optional: None.
(4) Nnwdaf_MLModelMonitor_Register service operation

A consumer may register use and monitoring capabilities for an ML model to an NWDAF including an MTLF
i) Inputs, Required: Consumer NF ID, unique ML model identifier.
ii) Inputs, Optional: Endpoint address of the Nnwdaf_MLModelMonitor_Subscribe service operation.
iii) Outputs, Required: ML model monitoring registration ID.
iv) Outputs, Optional: None.
(5) Nnwdaf_MLModelMonitor_Deregister service operation

When a consumer no longer uses or monitors accuracy of analytics generated by using an ML model, the consumer may cancel previous ML Model Monitor registration from an NWDAF including an MTLF.
i) Inputs, Required: ML model monitoring registration ID.
ii) Inputs, Optional: None.
iii) Outputs, Required: None.
iv) Outputs, Optional: None.

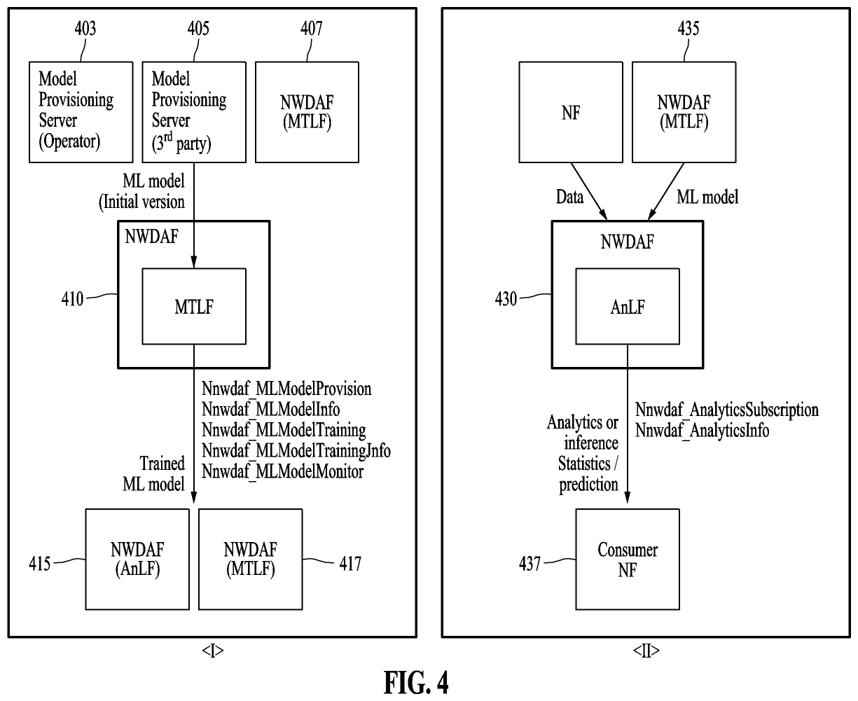

FIG. 4 is a diagram illustrating a structure of an NWDAF according to one embodiment.

A description of an operation of an NWDAF 410 including an MTLF is provided with reference to <I> of FIG. 4. The NWDAF 410 may receive an initial version of an ML model from a model provisioning server (operator) 403, a model provisioning server (third party) 405, or an NWDAF 407 including an MTLF. After the NWDAF 410 trains the initial version of ML model, the NWDAF 410 may provide a trained ML model to an NWDAF 415 including an AnLF or an NWDAF 417 including an MTLF through an ML model provisioning service (e.g., an Nnwdaf_MLModelProvision service) or an ML model information service (e.g., an Nnwdaf_MLModelInfo service). In addition, to update an ML model, the NWDAF 410 may use an Nnwdaf_MLModelTraining service or an Nnwdaf_MLModelTrainingInfo service.

A description of an operation of an NWDAF 430 including an AnLF is provided with reference to <II> of FIG. 4. The NWDAF 430 may collect data from a DCCF apparatus and/or a data source (e.g., an NF or an ADRF). The NWDAF 430 may receive an ML model from an NWDAF 435 including an MTLF. The NWDAF 430 may analyze collected data using an ML model. The NWDAF 430 may provide an analytics result of the data in the form of statistics or prediction to a consumer NF apparatus 437.

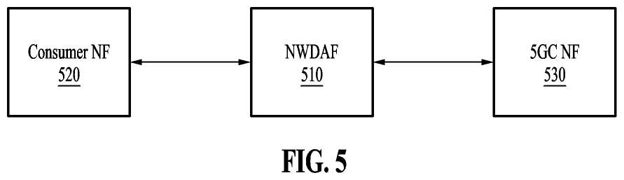

FIG. 5 is a diagram illustrating quality of service (QOS) and policy assistance analytics processes according to an embodiment.

An NWDAF 510 may provide analytics information (e.g., statistics and/or predictions) for QoS and policy assistance in response to a request from a consumer NF 520 (e.g., the PCF 160 of FIG. 1).

The NWDAF 510 may receive a request for the QoS and policy assistance analytics from the consumer NF 520. The consumer NF 520 may subscribe to analytics notifications (e.g., a Subscribe-Notify model) or may send a request for a single notification (e.g., a Request-Response model). The request for QoS and policy assistance analytics may be analytics information subscription (Nnwdaf_AnalyticsSubscription) or analytics information request (Nnwdaf_AnalyticsInfo). The consumer NF 520 may include the following parameters in the analytics information subscription (Nnwdaf_AnalyticsSubscription) or analytics information request (Nnwdaf_AnalyticsInfo).
Analytics ID=“QoS and Policy Assistance”
Target of analytics reporting
A list of one or more QoS parameter sets, and optionally, each is related to a QoS parameter set ID.
Non-empty value list(s) for all individual parameters of all QoS parameter sets.
Optionally, an input value for QoE (e.g., only a QoS parameter is included) and a value in which related predicted QoE is greater than or equal to the input value for QoE.
The analytics filter information may optionally include a DNN, an application ID or an SDF (service data flow) template, an AOI, and single-network slice selection assistance information (SS-NSSAI).
Analytics target period (e.g., indicating a time period over which the analytics are requested)
A notification correlation ID and a notification target address may be included in the subscription.
Optionally, preferred order of results for a list of candidate QoS parameter sets and QoE associated to the candidate QoS parameter sets:
Ordering criterion: “QoE” (e.g., QoE associated to the candidate QoS parameter set) or a “usage duration” of a QoS flow or “the number of usages” of the QoS flow,
Order: ascending or descending.
Optionally, reporting thresholds only applied to the subscription and indicating conditions for a level to be reached for respective analytics subsets

In addition, the consumer NF 520 may provide the following information to the NWDAF 510 to derive the QoS and policy assistance analytics.
One or more QoS parameter sets and an optionally associated QoS parameter set ID,
For the QoS parameter set, a list of values for all individual parameters (e.g., a non-empty list of values),
Optionally providing an input value for the QoE to request the NWDAF to report a candidate QoS set and a corresponding value (e.g., a value of the candidate QoS set) for which a predicted QoE is greater than or equal to the provided input value for QoE

The NWDAF 510 may collect the data for QoS and policy assistance analytics from a 5GC NF 530. The 5GC NF 530 may include one or more of the UE 100, the RAN 110, the AMF 120, the SMF 130, the UPF 140, the AF 150, the PCF 160, the NRF 170, the NEF 175, the MFAF 177, the DCCF 185, the ADRF 187, and/or the OAM 190 of FIG. 1.

The data collected by the NWDAF 510 from the 5GC NF 530 may include the data collected from an AF (e.g., the AF 150 of FIG. 1) on network data analytics related to observed service experience. The data collected from the AF on the network data analytics may include information about an application, a service experience, and QoE metrics and may be reused for the QoS and policy assistance analytics.

In addition, the NWDAF 510 may collect data collected from the 5GC NF 530, such as the AMF 120, the SMF 130, the UPF 140, and the PCF 160, related to the QoS and policy assistance information. Table 3 may indicate the data collected from the 5GC NF 530 related to the QoS and policy assistance information.

TABLE 3

| Information | Source | Description |
|---|---|---|
| QoS flows information | SMF | One or more list(s) of QoS flow |
| (1..max) | | information |
| > Used QoS parameter | SMF | The QoS parameter set(s) that have been |
| set(s) | | already applied by SMF. |
| | | The QoS parameter set includes QoS |
| | | parameters and QoS characteristics |
| | | attributes (as defined in TS 23.501 [2]). |
| > Used QoS profile | SMF | The QoS profile associated to the used |
| | | QoS parameter set(s). |
| > Event type | SMF | The type of QFI change, i.e., QoS Flow |
| | | establishment (i.e., QFI Change) or QoS |
| | | Flow termination (i.e., QFI deallocation) |
| | | or Traffic binding of QoS Flow event |
| > QFI | SMF | QoS flow identifier |
| > Traffic descriptor | SMF | One of application identifier or IP packet |
| | | filter set or ethernet packet filter set |
| > PDU Session ID | SMF | PDU session ID containing the QoS Flow |
| ..> S-NSSAI | SMF, AMF | Slice used to transport the QoS flow |
| UE identifier | SMF, AMF | The identifier of UE, e.g., SUPI, UE IP |
| | | address, etc. |
| UE Location | AMF | The UE location information, e.g. cell ID |
| | | or TAI. |
| Time stamp | SMF, AMF | The time stamp associated to the collected |
| | | data. |

The NWDAF 510 may generate analytics information on the QoS and policy assistance based on the collected data and may provide the analytics information (e.g., statistics of the QoS and policy assistance and/or predictions of the QoS and policy assistance) to the consumer NF 520. An example of an output of the analytics information from the NWDAF 510 may be a prediction of the QoS and policy assistance. The prediction of the QoS and policy assistance is shown in Table 4.

TABLE 4

| Information | Description |
|---|---|
| Time slot entry (1..max) | List of time slots during the analytics target period |
| > Time slot start | Time slot start within the analytics target period. |
| > Duration | Duration of the time slot. |
| QoS and Policy | List of QoS and Policy Assistance information |
| Assistance information | Max. is the number of the candidate QoS parameter set(s), if applicable. |
| (1..max) (Note 1) | |
| >> QoS parameter set | Identifies the QoS set for which the entry applies) |
| identifier | |
| >> DNN | DNN for the PDU Session which contains the QoS flow. |
| >> Application ID(s) | Identifies the application(s) that associated to the PCC rule or QoS. |
| >> Predicted QoE | The predicted QoE or the service experience (e.g., QoE, MOS) of the |
| (Note 7) | corresponding QoS parameter set (e.g., average, maximum, minimum). |
| >> Predicted QoE for | List of predicted QoE for each of the QoS parameter value |
| QoS parameter values | combinations provided by the analytics consumer. |
| (NOTE 5) | |
| >>> 5QI | The reference to 5G QoS characteristics and QoS parameters. |
| >>> ARP | he QoS parameter ARP contains information about the priority level, the |
| | pre-emption capability and the pre-emption vulnerability, as defined in |
| | TS 23.501 [2]. |
| >>> RQA (Note 4) | Reflective QoS Attribute (RQA) only applies to Reflective QoS. |
| | The Reflective QoS Attribute (RQA) is an optional parameter which |
| | indicates that certain traffic (not necessarily all) carried on this QoS |
| | Flow is subject to Reflective QoS, as defined in TS 23.501 [2]. |
| >>> Resource type | The resource type of the corresponding QoS flow, e.g., GBR QoS flow, |
| | non-GBR QoS flow, delay-critical QoS flow. |
| >>> Packet delay | Packet Delay Budget (PDB) indicates the upper bound for the time that |
| budget | a packet may be delayed between the UE and the N6 termination point |
| | at the UPF, as defined in TS 23.501 [2]. |
| >>> Packet error | Packet Error Rate (PER) defines an upper bound for a rate of non- |
| rate | congestion related packet losses, as defined in TS 23.501 [2]. |
| >>> Flow bit rates | The flow bit rates only applies to GBR QoS Flow. |
| (Note 2) | |
| >>>> GFBR | Guaranteed Flow Bit Rate (GFBR) for UL and/or DL. |
| >>>> MFBR | Maximum Flow Bit Rate (MFBR) for UL and/or DL. |
| >>> Packet loss | (The Maximum Packet Loss Rate (UL, DL) indicates the maximum rate |
| rate (Note 2) | for lost packets of the QoS Flow that can be tolerated in the uplink and |
| | downlink direction. |
| | This is provided to the QoS Flow if it is compliant to the GFBR |
| >>> Averaging | The Averaging window is applied when the resource type is GBR QoS. |
| window (Note 2) | The Averaging window represents the duration over which the GFBR |
| | and MFBR shall be calculated (e.g., in the (R)AN, UPF, UE), as defined |
| | in TS 23.501 [2]. |
| >>> Maximum | The Maximum Data Burst Volume (MDBV) applies to GBR QoS Flow |
| data burst volume (Note | with Delay-critical resource type. |
| 3) | The MDBV denotes the largest amount of data that the 5G-AN is |
| | required to serve within a period of 5G-AN PDB, as defined in |
| | TS 23.501 [2]. |
| >> Applicable | The applicable duration/time window of the QoS and Policy Assistance |
| duration of QoS and | information. |
| Policy Assistance | |
| information | |
| >> Validity period | The validity period within the time slot for the analytics on service |
| | experience associated to QoS. |
| >> Spatial validity | Area where the analytics on service experience associated to QoS |
| | applies. |
| >> Traffic descriptor | One of application identifier or IP packet filter set or ethernet packet |
| | filter set |
| >> Usage duration | Maximum/Minimum/Average usage duration of QoS Flows associated |
| information (Note 6) | to Candidate QoS parameter set. |
| >> Number of usage | The number of times that the QoS Flows associated to Candidate QoS |
| (Note 6) | parameter set to be used. |
| > Confidence | Confidence of this prediction. |

(Note 1):
Analytics subset that can be used in “list of analytics subsets that are requested”, and “Reporting Thresholds”.
(Note 2):
The output analytics only applies to GBR QoS Flow.
(Note 3):
The output analytics only applies to GBR QoS Flow with delay-critical resource type.
(Note 4):
The output analytics only applies to Reflective QoS.
(Note 5):
Only the parameters for which more than one candidate values have been provided shall be included, and only values which were provided by the consumer are allowed.
(Note 6):
The usage duration and number of usage of QoS Flow is determined by NWDAF using the SMF events QoS Flow establishment (i.e., QFI Change) or QoS Flow termination (i.e., QFI deallocation) or traffic binding of QoS Flow events. For example, the duration equals to the time period between the timestamp of QoS Flow establishment and QoS Flow termination events.
(Note 7):
The predicted QoE is reported for the entire QoS set if only one parameter value has been provided for each parameter and otherwise separately for each combination of parameter values.

The NWDAF 510 may provide one or more candidate QoS parameter sets, values of the candidate QoS parameter sets (e.g., values of individual parameters of the candidate QoS parameter sets), and a predicted QoE (e.g., if QOS settings are applied) to the consumer NF 520 through the QoS and policy assistance analytics. The NWDAF 510 may determine a predicted QoE for each individual value of the QOS parameter set and may provide a QoS parameter set in which the predicted QoE is greater than or equal to an input value for the QoE and a corresponding value thereof. The NWDAF 510 may only include a QoS parameter and a value provided by the consumer NF 520 for the request.

The QoS parameter set may include one or more of the following individual parameters.
QoS parameters: 5G QoS identifier (5QI), application and retention priority (ARP), reflective QoS attribute (RQA), guaranteed flow bit rate (GFBR), maximum flow bit rate and pack loss rate for a flow of a guaranteed bit rate (GBR), and a corresponding value of each QoS parameter;
QoS characteristics attributes (defined in clause 5.7.3 of TS 23.501): resource type, priority level, PDB, PER, averaging window, maximum data burst volume, and a corresponding value of each QoS characteristics attribute.
Service experience for edge application through UP path: service experience for UE, a group of UE, or any UE using an application or a set of applications over a specific UP path (e.g., UPF, DNAI, and EC servers).
Service experience for UE or a group of UE using an application or a set of applications through an RAT type or a frequency or both
Service experience for UE, a group of UE, or any UE using an application or a set of applications transmitting data through a PDU session having a PDU session parameter (e.g., S-NSSAI, DNN, PDU session type, SSC mode, and optionally, access type)

QOS characteristics may be included in the QoS parameter set only for the dynamically allocated and non-standardized 5QI.

The QoS and policy assistance analytics may be provided to individual UE, a group of UE (e.g., QoE is for an application ID related to one or more QoS flows of the UE) or an application (e.g., QoE is for a service flow of an application ID).

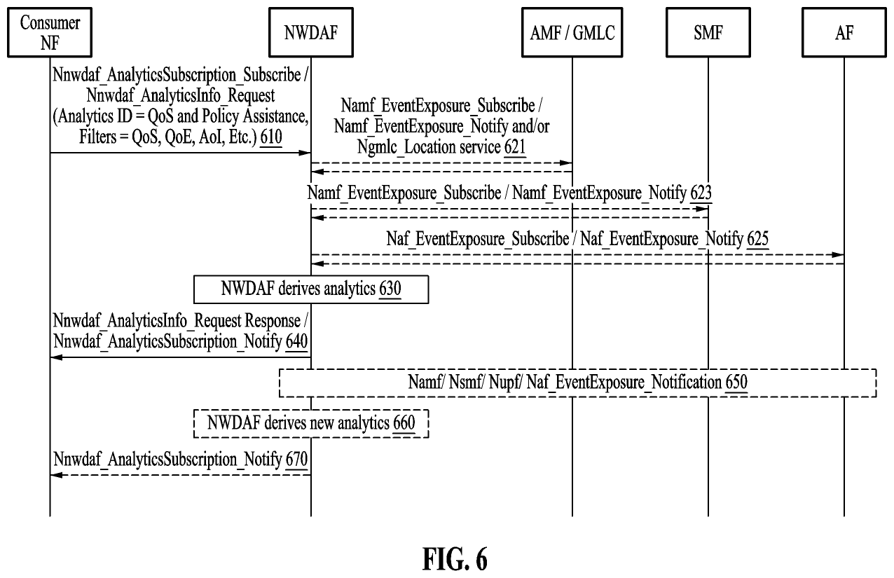

FIG. 6 is a flowchart illustrating a procedure for deriving and providing QoS and policy assistance analytics according to an embodiment.

In operation 610, a consumer NF (e.g., the PCF 160 of FIG. 1) may send a request or subscribe to an NWDAF (e.g., if the consumer NF is an untrusted AF, available through an NEF) for QoS and policy assistance analytics.

In operation 621, the NWDAF may subscribe to service data of an AMF (e.g., the AMF 120 of FIG. 1) that collects a UE location of UE, a group of UE, or any UE using an Namf_EventExposure_Subscribe service operation. When the required UE location information is finer granularity than a TA/cell level, the NWDAF may collect location data from a GMLC (gate mobile location centre) instead of the AMF by invoking an Ngmlc_Location service.

In operation 623, the NWDAF may subscribe to service data from an SMF (e.g., the SMF 130 of FIG. 1) by invoking a Nsmf_EventExposure_Subscribe service operation (e.g., an event ID, a parameter of a QoS parameter set, a QoS profile ID, SUPI(s) or an application ID).

In operation 625, the NWDAF may subscribe to service data from an AF (e.g., the AF 150 of FIG. 1 by invoking an Nnef_EventExposure_Subscribe or Naf_EventExposure_Subscribe (e.g., an event ID=QoS and policy assistance, an application ID, event filter information, a target of event reporting=−UD ID(s)) service.

In operation 630, the NWDAF may derive analytics requested for the QoS and policy assistance based on an NWDAF internal logic. For example, the NWDAF may directly derive analytics based on an input or may derive analytics by consuming an observed service experience and using an input parameter (e.g., the input parameter of Table 3).

In operation 640, the NWDAF may provide the requested QoS and policy assistance to the consumer NF using an Nnwdaf_AnalyticsInfo_Request response or Nnwdaf_AnalyticsSubscription_Notify according to the service used in operation 610.

In operations 650 to 670, if the consumer NF subscribes to the QoS and policy assistance in operation 610, when the NWDAF generates new analytics on a service experience associated with the QoS, the NWDAF may provide a notification to the consumer NF using Nnwdaf_AnalyticsSubscription_Notify.

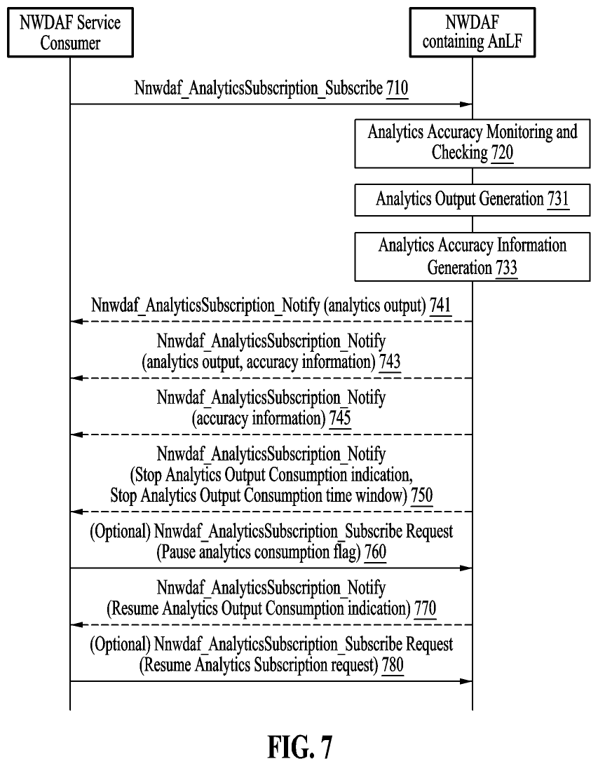

FIG. 7 is a diagram illustrating a procedure for subscribing to analytics accuracy information accuracy to an embodiment.

In operation 710, an NWDAF service consumer may select an NWDAF including an AnLF and may subscribe to or modify the subscription to analytics accuracy information by invoking an Nnwdaf_AnalyticsSubscription_Subscribe service operation. Parameters included in the subscription to check the accuracy information and trigger provisioning are described above. When the subscription is not an initial subscription request, the subscription may include analytics feedback information.

In operation 720, when receiving the subscription request, the NWDAF including the AnLF may verify a parameter of analytics accuracy request information received from the NWDAF service consumer in operation 710.

The NWDAF including the AnLF may begin analytics accuracy monitoring and generating analytics accuracy information related to an analytics ID indicated in the subscription according to a parameter defined in the analytics accuracy request information. The NWDAF including the AnLF may calculate the analytics accuracy information. When required data for the NWDAF including the AnLF is insufficient, reference data (and optionally used QoS parameters) may be collected by performing operation 733 before calculating the analytics accuracy information.

The NWDAF including the AnLF may begin analytics accuracy monitoring and generating the analytics accuracy information triggered by another NWDAF service consumer. When receiving a new request from the NWDAF service consumer, the NWDAF including the AnLF may determine whether collecting new data is required to generate the analytics accuracy information according to the corresponding analytics subscription.

In addition to the request from the NWDAF service consumer, the NWDAF including the AnLF may determine to begin analytics accuracy monitoring and generating the analytics accuracy information according to a local policy.

In operation 731, the NWDAF including the AnLF may perform data collection for a subscribed analytics ID and may generate an analytics output.

In operation 733, the NWDAF including the AnLF may perform data collection (e.g., ground truth data collection, used QoS parameters) to generate the accuracy information on the subscribed analytics ID and may generate associated analytics accuracy information. When the analytics feedback information is included in operation 710, the NWDAF including the AnLF may determine whether reference ground truth data is affected by an internal logic for generating the analytics accuracy information by considering the analytics feedback information.

When the analytics ID is set to “QoS and policy assistance”, the NWDAF including the AnLF may check whether a used QoS parameter coincides with a parameter of the analytics output. The NWDAF including the AnLF may calculate the analytics accuracy only for the reference ground truth data (e.g., the QoE) for which the candidate QOS parameter set of the analytics output is used.

In operation 741, when the analytics accuracy request information included in the subscription does not exist in operation 710, the NWDAF including the AnLF may provide an analytics output according to a parameter defined in the analytics reporting information included in the subscription request.

In operation 743, the NWDAF including the AnLF may provide the analytics accuracy information together with the analytics output for the analytics ID according to the parameter defined in the analytics accuracy request information included in the subscription request.

In operation 745, the NWDAF including the AnLF may provide only the analytics accuracy information for the analytics ID according to the parameter defined in the analytics accuracy request information included in the subscription request. When the periodicity of providing the analytics accuracy information indicated in the analytics accuracy request information is different from the periodicity of providing the analytics output indicated in the subscription request or an accuracy value is below an analytics accuracy threshold (e.g., the analytics accuracy threshold is shown in the subscription request or is locally configured), the analytics accuracy information may be provided as a separate notification.

In operation 750, if it is determined that the accuracy for the analytics ID is low or insufficient, in other words, if a deviation between an output and ground truth data (collected from a data generator NF corresponding to an analytics ID requested at the time of reference by the prediction) fails to satisfy an analytics accuracy requirement using a trained ML model or the accuracy value is below the analytics accuracy threshold (locally configured or received from the subscription request), the NWDAF including the AnLF may notify the NWDAF service consumer using a Stop Analytics Output Consumption indication and a Stop Analytics Output Consumption time window.

In operation 760 (optional), the NWDAF service consumer may determine to stop consuming the analytics output according to its own logic without cancelling the analytics ID subscription or according to the notification received from the NWDAF having the Stop Analytics Output Consumption indication. The NWDAF service consumer may modify an existing subscription by invoking an Nnwdaf_AnalyticsSubscription_Subscribe service operation including the subscription and may provide a parameter pause analytics consumption flag in the analytics accuracy request information.

In operation 770, when the NWDAF determines that the accuracy of the analytics ID is improved (e.g., satisfy the accuracy requirement of the analytics consumer) or a Stop Analytics Output Consumption time window set by itself is finished, the NWDAF may notify the NWDAF service consumer of the accuracy information on the analytics ID to resume the consumption of the analytics output, and thereby, may reactivate an existing analytics ID subscription that has been previously stopped.

In operation 780 (optional), since the NWDAF service consumer may notify the NWDAF to resume the analytics output notification based on its own logic, the paused existing analytics ID subscription may be reactivated by the NWDAF service consumer request (e.g., operation 760) or the NWDAF indication (e.g., operation 750). The NWDAF service consumer may modify the existing subscription by invoking the Nnwdaf_AnalyticsSubscription_Subscribe service operation including the subscription correlation ID and may provide an analytics subscription resume request parameter to the analytics accuracy request information.

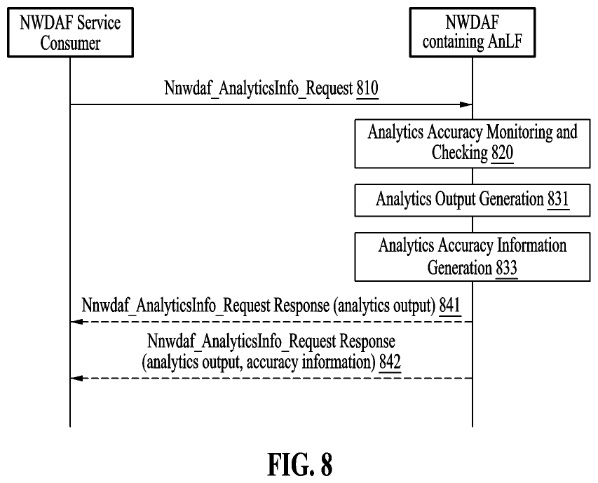

FIG. 8 is a diagram illustrating a procedure for requesting for analytics accuracy information according to an embodiment.

In operation 810, the NWDAF service consumer may select an NWDAF including an AnLF and may send a request for the analytics accuracy information by invoking the Nnwdaf_AnalyticsInfo_Request service operation. A parameter included in the request to check the accuracy information and trigger provisioning is described above.

In operation 820, when receiving the request, the NWDAF including the AnLF may determine whether the request is only for generating an analytics output or includes an analytics accuracy request.

When the analytics accuracy request is included, the NWDAF including the AnLF may begin analytics accuracy monitoring, may generate the analytics accuracy information related to the analytics ID indicated in the request, and may perform analytics accuracy monitoring based on a parameter defined in the analytics accuracy request information. The NWDAF including the AnLF may calculate the analytics accuracy information. When required data for the NWDAF including the AnLF is insufficient, reference data (and optionally used QoS parameters) may be collected by performing operation 833 before calculating the analytics accuracy information.

The NWDAF including the AnLF may begin analytics accuracy monitoring and generating the analytics accuracy information triggered by another NWDAF service consumer. When receiving a new request from the NWDAF service consumer, the NWDAF including the AnLF may determine whether collecting new data is required to generate the analytics accuracy information according to the corresponding analytics request.

In addition to the request from the NWDAF service consumer, the NWDAF including the AnLF may determine to begin analytics accuracy monitoring and generating the analytics accuracy information according to a local policy.

In operation 831, the NWDAF including the AnLF may perform data collection for a requested analytics ID and may generate an analytics output.

In operation 833, the NWDAF including the AnLF may perform data collection (e.g., ground truth data collection, used QoS parameters) to generate the accuracy information on the requested analytics ID and may generate associated analytics accuracy information.

When the analytics ID is set to “QoS and policy assistance”, the NWDAF including the AnLF may check whether a used QoS parameter coincides with a parameter of the analytics output. The NWDAF including the AnLF may calculate the analytics accuracy only for the reference ground truth data (e.g., the QoE) for which the candidate QoS parameter set of the analytics output is used.

In operation 841, when the analytics accuracy request information is not included in the request in operation 810, the NWDAF including the AnLF may provide an analytics output according to a parameter defined in the analytics reporting information included in the request.

In operation 843, the NWDAF including the AnLF may provide the analytics accuracy information and the requested analytics output for the analytics ID according to the parameter defined in the analytics accuracy request information included in the request.

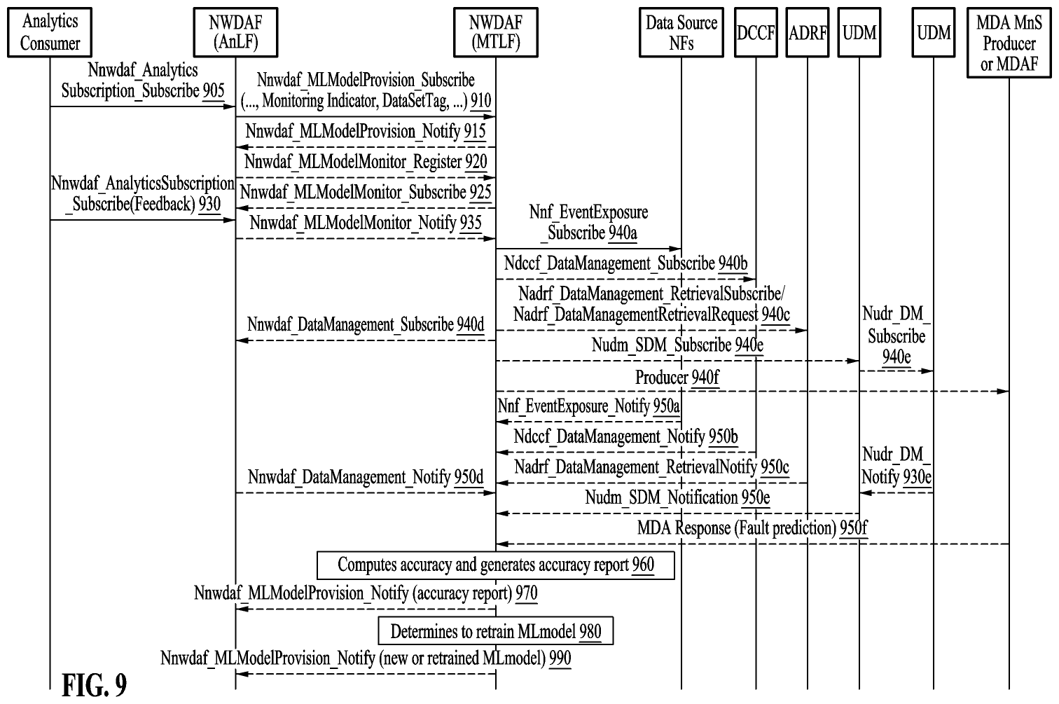

FIG. 9 illustrates an example of a procedure for machine learning (ML) model accuracy monitoring according to one embodiment.

FIG. 9 may show a procedure for monitoring the accuracy of an ML model provisioned using newly collected data. An NWDAF including the AnLF may provide inference data to the NWDAF including the MTLF for model accuracy monitoring and the NWDAF including the MTLF may determine retraining or reprovisioning of the ML model.

In operation 905, an analytics consumer (e.g., referred to as a consumer NF, a service consumer NF, or an NWDAF service consumer) may initiate subscription to an analytics exposure service for an NWDAF including an AnLF.

In operation 910, the NWDAF including the AnLF may send a request to an NWDAF including an MTLF (e.g., an appropriate NWDAF) for an ML model using an Nnwdaf_MLModelProvision_Subscribe service operation. The NWDAF including the AnLF may include an analytics accuracy threshold (e.g., an ML model accuracy threshold) used as an indicator (e.g., a monitoring indicator) to execute an accuracy monitoring operation. The NWDAF including the AnLF may include DataSetTag and/or an ADRF ID. These (e.g., DataSetTag and/or the ADRF ID) may be used to load, from the ADRF, and store inference data (e.g., including input data, prediction, and ground truth data at a time when prediction refers to) relevant to ML model accuracy monitoring and retraining or reprovisioning. Nnwdaf_MLModelProvision_Subscribe may include a monitoring indicator, DataSetTag and/or the ADRF ID.

When the NWDAF including the AnLF receives an ML model, the NWDAF including the AnLF may transmit an MTLF including a set of tuples (e.g., a unique ML model identifier and DataSetTag, and/or an ADRF ID) by invoking an Nnwdaf_MLModelProvision_Subscribe service operation to modify the subscription.

In operation 915, the NWDAF including the MTLF may provide a trained ML model to the NWDAF including the AnLF. The NWDAF including the MTLF may include accuracy information used to indicate the accuracy of the ML model during training. Nnwdaf_MLModelProvision_Notify may include the accuracy information.

If operation 910 is for modifying the subscription (e.g., including the subscription correlation ID) and includes a set of tuples (e.g., a unique ML model identifier and DataSet Tag, and/or an ADRF ID), the NWDAF including the MTLF may determine a relationship between the ML model and DataSetTag.

In operation 920, the NWDAF including the AnLF may register the use of the ML model to the NWDAF including the MTLF. The NWDAF including the AnLF may show a capability of transmitting analytics feedback information of the analytics consumer and/or the ML model accuracy information on the ML model by registering the use of the ML model to the NWDAF including the MTLF.

In operation 925, due to the registration in operation 920, the NWDAF including the MTLF may subscribe to the NWDAF including the AnLF to obtain the analytics feedback information from the analytics consumer and/or the ML model accuracy information on the provisioned ML model by invoking the Nnwdaf_MLModelMonitor_Subscribe service operation. This may be a case in which a corresponding service operation (e.g., the Nnwdaf_MLModelMonitor_Subscribe service operation) is supported by the NWDAF including the AnLF.

In operation 930, the analytics consumer may transmit the analytics feedback information as an Nnwdaf_AnalyticsSubscription_Subscribe message.

In operation 935, as requested in operation 925, the NWDAF including the AnLF may transmit the ML model accuracy information on the provisioned ML model and/or the analytics feedback information received from the analytics consumer by invoking the Nnwdaf_MLModelMonitor_Notify service operation. When the NWDAF including the MTLF receives the analysis feedback information or the ML model accuracy, the NWDAF including the MTLF may improve the ML model accuracy by triggering operations 940a to 990.

In operations 940a to 940f, the NWDAF including the MTLF may determine whether to perform ML model accuracy monitoring and retraining or reprovisioning of the ML model by collecting new data from various data sources based on the NWDAF (e.g., at least one) including the AnLF or a request of a corresponding local policy.

In operations 940a and 940b, the NWDAF including the MTLF may collect new data for ML model accuracy monitoring, retraining, and reprovisioning from data source NFs and a DCCF by respectively invoking Nnf_EventExposure_Subscribe and Ndccf_DataManagement_Susbscribe service operations.

In operations 940c and 940d, when the ADRF ID and/or DataSetTag is provided in operation 910, the NWDAF including the MTLF may retrieve historical data (e.g., historical analytics) from an ADRF designated by the NWDAF including the AnLF in operation 910 by invoking an Nadrf_DataManagementRetrievalRequest or Nadrf_DataManagementRetrieval_Subscribe service operation. Otherwise, the NWDAF including the MTLF may retrieve historical data (e.g., historical analytics) from the NWDAF including the AnLF or the DCCF by respectively invoking Ndccf_DataManagement_Subscribe and Nnwdaf_DataManagement_Subscribe service operations.

When the NWDAF including the AnLF does not include DataSetTag having the ADRF ID in operation 910, the NWDAF including the MTLF may send a request to the ADRF for data collection and analytics corresponding to the analytics generated by the ML model provided in operation 915.

In operation 940e, the NWDAF including the MTLF may join the UDM to receive a notification of modification within subscription data for a target of ML model reporting by invoking an Nudm_SDM_Subscribe service operation and the UDM may subscribe to a notification of modification of UE subscription data by invoking an Nudr_DM_Subscribe service operation of a UDR.

In operation 940f, the NWDAF including the MTLF may consider data quality for accuracy monitoring by collecting fault prediction analytics data from an MDAS to determine states of data source NFs using an MDA request.

When the NWDAF including the MTLF already collected new test data and performed ML model accuracy monitoring and retraining (e.g., triggered by another NWDAF including an AnLF for ML model accuracy monitoring and retraining), the NWDAF including the MTLF may determine whether to use data to subscription based on its internal logic.

In operations 950a to 950f, the NWDAF including the MTLF may receive data requested by various sources as requested in operations 940a to 940f.

In operation 960, based on the data and analytics collected in operations 950a to 950f, the NWDAF including the MTLF may compute accuracy using prediction and actual measured data observed at a time when the prediction refers to. The NWDAF including the MTLF may discard data of a corresponding data source when NWDAF including the MTLF detects that the data quality of the data source is poor. When only the input data and ground truth data are allowed to be used, the NWDAF including the MTLF may generate prediction with the input data collected to compute the accuracy.

When the analytics ID is set to “QoS and policy assistance”, the NWDAF including the MTLF may check whether a used QoS parameter coincides with a parameter of the inference data provided by the NWDAF including the AnLF or retrieved from the ADRF. The NWDAF including the MTLF may calculate the analytics accuracy only for the reference ground truth data (e.g., the QoE) for which the candidate QoS parameter set included in the inference data.

A method in which the NWDAF including the MTLF determines whether data from a data source is good quality or needs to be discarded may depend on NWDAF implementation and configuration.

In operation 970, the NWDAF including the MTLF may transmit an accuracy report (e.g., including the accuracy computed in operation 960) to the NWDAF including the AnLF.

For example, when a reporting threshold is satisfied, the NWDAF including the MTLF may transmit the accuracy report to the NWDAF including the AnLF by invoking an Nnwdaf_MLModelProvision_Notify service operation.

In operation 980, based on the computed accuracy, the NWDAF including the MTLF may retrain or reprovision an ML model.

In operation 990, when a newly generated ML model or a retrained ML model is prepared, the NWDAF including the MTLF may transmit the newly generated ML model or the retrained ML model to the NWDAF including the AnLF by invoking the Nnwdaf_MLModelProvision_Notify service operation. The NWDAF including the MTLF may transmit the accuracy report of the newly generated ML model or the retrained ML model to the NWDAF including the AnLF.

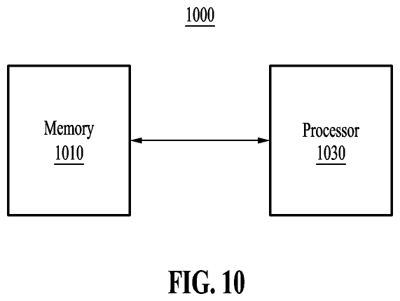

FIG. 10 is a schematic block diagram of an apparatus for performing an NWDAF according to one embodiment.

Referring to FIG. 10, according to one embodiment, an apparatus 1000 for performing an NWDAF (e.g., a server apparatus) may be substantially the same as the NWDAF (e.g., an NWDAF including an AnLF or an NWDAF including an MTLF) described with reference to FIGS. 1 to 9. The apparatus 1000 may include a memory 1010 and a processor 1030. The apparatus 1000 may function as an NWDAF including an AnLF or an NWDAF including an MTLF.

The memory 1010 may store instructions (or programs) executable by the processor 1030. For example, the instructions include instructions for performing an operation of the processor 1030 and/or an operation of each component of the processor 1030.

The memory 1010 may be implemented as a volatile or non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

The processor 1030 may execute computer-readable code (e.g., software) stored in the memory 1010 and instructions triggered by the processor 1030. The processor 1030 may be a data processing device implemented by hardware including a circuit having a physical structure to perform desired operations. The desired operations may include code or instructions included in a program. For example, the hardware-implemented data processing device may include a microprocessor, a CPU, a processor core, a multi-core processor, a multiprocessor, an application-specific integrated circuit (ASIC), and a field-programmable gate array (FPGA).

An operation performed by the processor 1030 may be substantially the same as the operation of the NWDAF (e.g., the NWDAF including the AnLF or the NWDAF including the MTLF) described with reference to FIGS. 1 to 9. Accordingly, a detailed description thereof is omitted.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of providing analytics information, the method comprising:
receiving a request for analytics of quality of service (QOS) and policy assistance from a consumer network function (NF);
collecting data for the analytics of the QoS and policy assistance from a 5G core (5GC) NF;
generating the analytics information on the QoS and policy assistance based on the collected data; and
transmitting the analytics information to the consumer NF.

2. The method of claim 1, wherein the consumer NF is a policy control function (PCF).

3. The method of claim 1, wherein the analytics information comprises:
a candidate QoS parameter set;
values of individual parameters of the candidate QoS parameter set; and
predicted quality of experience (QoE).

4. The method of claim 1, wherein the generating comprises:
deriving the analytics information using an observed service experience.

5. The method of claim 1, wherein the request comprises a request for monitoring analytics accuracy of the analytics of the QoS and policy assistance.

6. The method of claim 1, further comprising:
receiving analytics feedback information from the consumer NF,
wherein the analytics feedback information comprises a candidate QoS parameters set indication used for an action.

7. A server device for providing analytics information, the server device comprising:
a processor; and
a memory electrically connected to the processor and configured to store instructions executable by the processor,
wherein, when the instructions are executed by the processor, the instructions cause the server device to perform a plurality of operations, and
the plurality of operations comprises:
receiving a request for analytics of quality of service (QOS) and policy assistance from a consumer network function (NF);
collecting data for the analytics of the QoS and policy assistance from a 5G core (5GC) NF;
generating the analytics information on the QoS and policy assistance based on the collected data; and
transmitting the analytics information to the consumer NF.

8. The server device of claim 7, wherein the consumer NF is a policy control function (PCF).

9. The server device of claim 7, wherein the analytics information comprises:
a candidate QoS parameter set;
values of individual parameters of the candidate QoS parameter set; and
predicted quality of experience (QoE).

10. The server device of claim 7, wherein the generating comprises:
deriving the analytics information using an observed service experience.

11. The server device of claim 7, wherein the request comprises a request for monitoring analytics accuracy of the analytics of the QoS and policy assistance.

12. The electronic device of claim 7, wherein the plurality of operations further comprises:
receiving analytics feedback information from the consumer NF, and
the analytics feedback information comprises a candidate QoS parameters set indication used for an action.
